(19) United States
(12) Patent Application Publication
(10) Pub. No.: US 2013/0060481 A1
(43) Pub. Date: Mar. 7, 2013

(54) Systems and Methods for Identifying Structurally or Functionally Significant Nucleotide Sequences

(71) Applicants: Joseph J. Grzymski, Reno, NV (US); Adam G. Marsh, Lewes, DE (US)

(72) Inventors: Joseph J. Grzymski, Reno, NV (US); Adam G. Marsh, Lewes, DE (US)

(73) Assignees: Board of Regents of the Nevada System of Higher Ed ucation,on behalf of The Desert Reserach Institut, Reno, NV (US); University of Delaware, Newark, DE (US)

(21) Appl. No.: 13/522,361

(22) PCT Filed: Jan. 18, 2011
(86) PCT No.: PCT/US2011/021562

§ 371 Date: Oct. 29, 2012

Related U.S. Application Data
(60) Provisional application No. 61/295,605, filed on Jan. 15, 2010.

(51) Int. Cl. G06F 19/20

(52) U.S. Cl. 702/20

(57) ABSTRACT

Provided are methods, systems, and computer readable media for comparing word statistics between a significant amino acid sequence and a significant nucleotide sequence wherein the comparison instructs further research.

### CROSS REFERENCE TO RELATED APPLICATION

This application claims benefit of and priority to U.S. Provisional Patent Application Ser. No. 61/295,605 filed Jan. 15, 2010, which is fully incorporated herein by reference and made a part hereof.

### FIELD OF THE INVENTION

The present invention relates to the field of drug development, and more particularly to systems and methods for identifying structurally or functionally significant nucleotide sequences.

### BACKGROUND

Microorganisms exhibit a wide range of environmental adaptations and lifestyles encoded by their genomes. Our understanding of the “limits” of microbial life on Earth has continued to expand as microbes are found in myriad, unique environments and as synthetic biology has developed to explore the minimum gene sets required for life. Progress in both fields, however, is currently limited by lack of understanding of the genomic rule set or principles that shape gene structure and organization for either life in a specific habitat (e.g., hydrothermal vent, metazoan host, industrial bioreactor) or a defined life-history strategy (e.g., chemoautotrophy, heterotrophy, methanotrophy). Pathogens containing nearly minimal gene sets needed to survive in a host are generally considered to have smaller genome sizes and less complexity than free-living organisms. Genome size, however, is merely a consequence of net gene loss (or gain); it cannot be used to distinguish free living organisms from pathogens. This issue occurs because of the broad overlap in genome sizes that exist between these two groups. Therefore, what is needed are systems and methods that overcome challenges found in the art, some of which are described above.

### SUMMARY

Described herein systems, methods and computer readable media for identifying structurally or functionally significant nucleotide sequences. Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 is a diagram depicting an exemplary system for identifying significant nucleotide sequences in accordance with one aspect of the present invention;

FIG. 2 is a flow chart of exemplary steps providing an overview for identifying significant nucleotide sequences for use in drug development in accordance with an aspect of the present invention;

FIG. 3 is a flow chart of exemplary steps for identifying significant nucleotide sequences in accordance with an aspect of the present;

FIG. 4 is a flow chart of exemplary steps for outputting genome, coding, and non-coding word dictionaries in accordance with an aspect of the present invention;

FIG. 5 is an illustration for use in explaining the determination of a nucleotide sequence selection score for a nucleotide sequence;

FIG. 6 is an exemplary illustration of a comparison of the word statistics in genes between the nucleotide and amino acid sequences of Klebsiella pneumoniae NTIJH-K2044, in accordance with an aspect of the present invention;

FIG. 7 is a flow chart of exemplary steps for comparing differences in nucleotide sequences and amino acid sequences;

FIG. 8 is an exemplary illustration of the results of a comparison of the nucleotide word information from one genome to that of the another genome, in accordance with an aspect of the present invention;

FIG. 9 is a flow chart of exemplary steps for determining selection score on at least two genomes;

FIG. 10 is an exemplary illustration of the results of a method and system of identifying and targeting the most prevalent word types in genes and genomes;

FIG. 11 is a flow chart of exemplary steps for comparing word statistics between a significant amino acid sequence and a significant nucleotide sequence; and

FIG. 12 is a flow chart of exemplary steps for identifying a significant nucleotide sequence.

### DETAILED DESCRIPTION

Before the present methods and systems are disclosed and described, it is to be understood that the methods and systems are not limited to specific synthetic methods, specific components, or to particular compositions. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the Examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

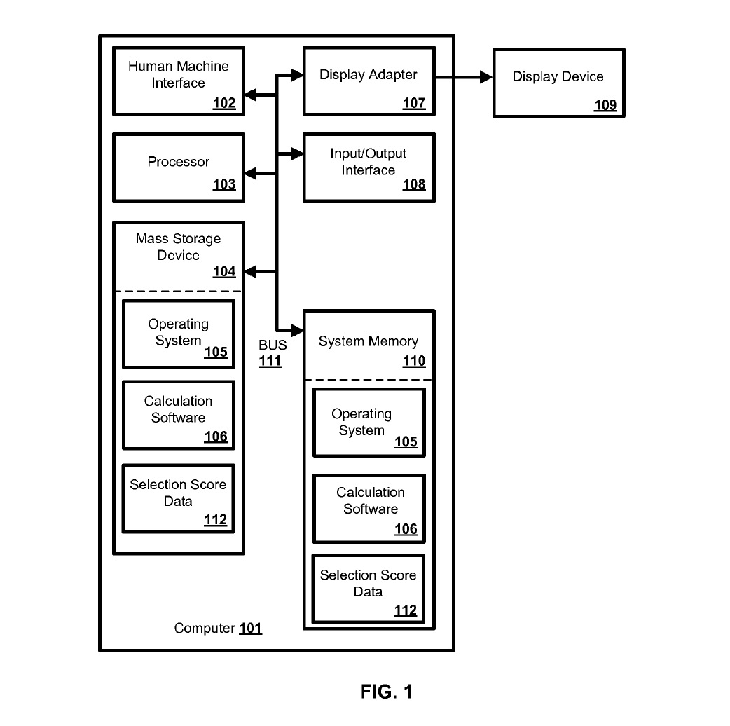

An exemplary system for identifying structurally or functionally significant nucleotide sequences from an organism's genome, in accordance with one aspect of the present invention is illustrated in FIG. 1. As explained below, the system can calculate the statistical differences in nucleotide sequences versus amino acid sequences to predict areas in nucleotide sequences that may be targeted for drug development. Further, the system maintains the ability to compare the nucleotide word information from one genome (e.g. a Virus) to that of another genome (e.g. the viral host). This results in a comparison of nucleotide information at the whole genome or gene level to reveal areas of major differences and similarities that exceed simple comparison word-matching. A significant sequence can refer to nucleotide sequences that are highly impacted by natural selection such that they may reveal the degree to which those sequences have been protected from random drift mutations. Determining significance is directly associated with the degree of evolutionary pressure exerted by natural selection that can be observed for any given nucleotide sequence in a genome. These sequences may be good targets for further analysis because they are directly implicated in core functioning of organisms and thus many of the top ranking sequences already are the core targets of fundamental antibiotics (e.g. Topoisomerase, RNA polymerase, Gyrase). Thus, other top scoring nucleotide sequences (coding or non-coding) that have high scores may be significant for further study. These sequences may relate to hypothetical proteins and non-coding DNA. In the past, this information was ignored because with hypothetical proteins there was no way of prioritizing which of the between 40-70% of the proteins that are hypothetical were important and worthy of further study. Similarly, this information was ignored for non-coding DNA. The exemplary system is capable of identifying these significant sequences to determine which should be used for further study.

FIG. 1 is a block diagram illustrating an exemplary operating environment for performing the disclosed methods. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The present methods and systems can be operational with numerous other general purpose or special purpose computing system environments or configurations. Examples of well known computing systems, environments, and/or configurations that can be suitable for use with the systems and methods comprise, but are not limited to, personal computers, server computers, laptop devices, gaming systems and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

Further, one skilled in the art will appreciate that the systems and methods disclosed herein can be implemented via a general-purpose computing device in the form of a computer 101. The components of the computer 101 can comprise, but are not limited to, one or more processors or processing units 103, a system memory 110, and a system bus 111 that couples various system components including the processor 103 to the system memory 110. In the case of multiple processing units 103, the system can utilize parallel computing. In one exemplary embodiment, processor 103 receives electronic data including data relating to one or more genomes. In another exemplary embodiment, processor 103 receives electronic data including an observed frequency of each nucleotide word in the genome. Processor 103 is configured to process electronic data. Processor 103 may transform the electronic data into another format. In one exemplary embodiment, the transformed electronic data may include one or more nucleotide word dictionaries for a genome. In another exemplary embodiment, the transformed electronic data may include one or more nucleotide word dictionaries for coding and non-coding regions. In another exemplary embodiment, the transformed electronic data may include one or more selection scores (described below) for a genome. The transformed electronic data may be stored in mass storage device 104 (described below), system memory 110 (described below), or transmitted to display device 109 (described below).

The system bus 111 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 111, and all buses specified in this description can also be implemented over a wired or wireless network connection and each of the subsystems, including the processor 103, a mass storage device 104, an operating system 105, calculation software 106, selection score data 112, system memory 110, an Input/Output Interface 108, a display adapter 107, a display device 109, and a human machine interface 102, can be contained within one or more remote electronic modules at physically separate locations, connected through buses of this form, in effect implementing a fully distributed system.

The computer 101 typically comprises a variety of computer readable media. Exemplary readable media can be any available media that is accessible by the computer 101 and comprises, for example and not meant to be limiting, both volatile and non-volatile media, removable and non-removable media. The system memory 110 comprises computer readable media in the form of volatile memory, such as random access memory (RAM), and/or non-volatile memory, such as read only memory (ROM). The system memory 110 typically contains data such as selection score data 112, and/or program modules such as operating system 105 and calculation software 106 that are immediately accessible to and/or are presently operated on by the processing unit 103.

In another aspect, the computer 101 can also comprise other removable/non-removable, volatile/non-volatile computer storage media. By way of example, FIG. 1 illustrates a mass storage device 104 which can provide non-volatile storage of computer code, computer readable instructions, data structures, program modules, and other data for the computer 101. For example and not meant to be limiting, a mass storage device 104 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

In one exemplary embodiment, electronic data including data relating to one or more genomes may be stored on mass storage device 104. In another exemplary embodiment, electronic data including one or more nucleotide word dictionaries for one or more genomes may be stored on mass storage device 104. In yet another exemplary embodiment, electronic data including one or more selection scores for one or more genomes may be stored on mass storage device 104. A suitable data storage device for use with the present invention will be understood by one of skill in the art from the description herein.

Optionally, any number of program modules can be stored on the mass storage device 104, including by way of example, an operating system 105, selection score data 112, and calculation software 106. Each of the operating system 105, selection score data 112, and calculation software 106 (or some combination thereof) can comprise elements of the programming and the calculation software 106. Selection score data 112, can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple systems. In one exemplary embodiment, the selection score data 112, may include data relating to one or more genomes. In another exemplary embodiment, the selection score data 112, may include the observed frequency of each nucleotide word in the one or more genomes.

In another aspect, the user can enter commands and information into the computer 101 via an input device (not shown). Examples of such input devices comprise, but are not limited to, a keyboard, pointing device (e.g., a “mouse”), a microphone, a joystick, a scanner, tactile input devices such as gloves, and other body coverings, and the like These and other input devices can be connected to the processing unit 103 via a human machine interface 102 that is coupled to the system bus 111, but can be connected by other interface and bus structures, such as a parallel port, game port, an IEEE 1394 Port (also known as a Firewire port), a serial port, or a universal serial bus (USB).

In yet another aspect, a display device 109 can also be connected to the system bus 111 via an interface, such as a display adapter 107. It is contemplated that the computer 101 can have more than one display adapter 107 and the computer 101 can have more than one display device 109. For example, a display device can be a monitor, an LCD (Liquid Crystal Display), or a projector. In addition to the display device 109, other output peripheral devices can comprise components such as speakers (not shown) and a printer (not shown) which can be connected to the computer 101 via Input/Output Interface 108. Any step and/or result of the methods can be output in any form to an output device. Such output can be any form of visual representation, including, but not limited to, textual, graphical, animation, audio, tactile, and the like.

For purposes of illustration, application programs and other executable program components such as the operating system 105 are illustrated herein as discrete blocks, although it is recognized that such programs and components reside at various times in different storage components of the computing device 101, and are executed by the data processor(s) of the computer. An implementation of calculation software 106 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

Among the software elements included in computer system 101 are a calculation package 106 and a selection score package 112 that, in conjunction with the hardware and other elements of computer system 101, described above, affect the methods of the present invention. A calculation software package 106 and a selection score package 112 are illustrated conceptually for purposes of illustration as residing in system memory 110, but as persons skilled in the art can appreciate, may not actually be stored or otherwise reside in memory in their entirety at any given time. Rather, portions or elements of each may be retrieved and executed or referenced on an as-needed basis in accordance with conventional operating system processes. It should be noted that calculation software package 106 and selection score package 112, as stored in or otherwise carried on any computer-usable data storage or transmission medium, can constitute a “computer program product” within the meaning of that term as used in the context of patent claims.

The methods and systems can employ Artificial Intelligence techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

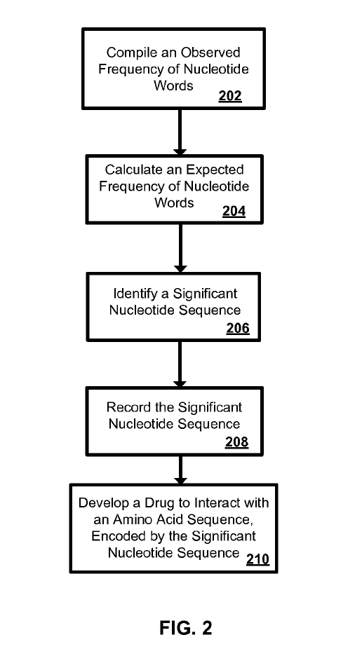

FIG. 2 is a flow chart of exemplary steps for identifying significant nucleotide sequences for use in drug development in accordance with an aspect of the present invention. To facilitate description, the steps of FIG. 2 are described with reference to the system components of FIG. 1. It will be understood by one of skill in the art from the description herein that one or more steps may be omitted and/or different components may be utilized without departing from the scope of the present invention.

In step 202, an observed frequency of nucleotide words in the genome is compiled. In an exemplary embodiment, processor 103 receives data relating to a genome from input/output interface(s) 108. Processor 103 may then count the number of times each nucleotide word occurs in each nucleotide sequence, and compile a list of the observed frequencies for each nucleotide word. The list of the observed frequencies of nucleotide words may be stored in mass storage device 104 and/or in system memory 110.

In step 204, an expected frequency of nucleotide words in each nucleotide sequence is calculated, e.g., with a general or specific purpose computer. The expected frequency of each nucleotide word may be calculated based at least in part on the observed nucleotide word frequency list compiled in step 202. In an exemplary embodiment, processor 103 calculates an expected frequency of a nucleotide word based on the observed frequencies of two or more nucleotide subwords that make up the nucleotide word. As used herein, a nucleotide subword is a nucleotide word occurring within another nucleotide word. Processor 103 may then compile a list of the expected frequencies for each nucleotide word. The list of the expected frequencies of nucleotide words may then be stored in mass storage device 104 and/or in system memory 110.

In step 206, a structurally or functionally significant nucleotide sequence is identified. The structurally or functionally significant nucleotide sequence may be identified based at least in part on the observed and expected nucleotide word frequencies compiled in steps 202 and 204. In an exemplary embodiment, processor 103 generates a selection score for each nucleotide sequence based on the difference between the expected and observed word frequencies for each nucleotide in the sequence. The maximum selection scores correspond to nucleotide sequences occurring more frequently in the genomes than is expected from its expected frequency, which indicates that it is structurally or functionally significant to the organism.

The identification of the structurally or functionally significant nucleotide sequence may be additionally based on a comparison of the nucleotide word frequencies in the genome (e.g., a genome of a pathogenic bacteria) to the nucleotide frequencies in a related genome (e.g., a genome of a non-pathogenic bacteria related to the pathogenic bacteria). In accordance with this embodiment, differences between the nucleotide frequencies of the pathogenic genome and the non-pathogenic genome may be used to identify nucleotide words that are significant to the pathogenic bacteria but not to the non-pathogenic bacteria, e.g., nucleotide words having a greater frequency in the pathogenic bacteria than the non-pathogenic bacteria. This may provide further information on the different effects of natural selection on the genome of a pathogen as opposed to the effects of natural selection on the genome of a non-pathogen. Other exemplary comparisons can occur between pairings which include, but are not limited to: a pathogenic genome and its host genome, genomes from disparate environmental conditions, synthetic genomes and the related non-synthetic genome, and any other pairings which may result in the identification of one or more significant nucleotide sequences.

In step 208, the structurally or functionally significant nucleotide sequence is stored and/or presented. In one exemplary embodiment, the selection scores for one or more structurally or functionally significant nucleotide sequences may be stored in mass storage device 104. In another exemplary embodiment, processor 103 may transmit electronic data to display adapter 107. The electronic data may include the selection scores for one or more structurally or functionally significant nucleotide sequences in the genome. Display device 109 may then present the selection scores to a user by, for example, a chart or graph indicating the comparative height of the selection scores for the one or more structurally or functionally significant nucleotide sequences presented on a monitor or printed on paper. Electronic data transmitted to display device 109 may be at least temporarily stored, e.g., in a video buffer (not shown).

Identifying one or more structurally or functionally significant nucleotide sequences of a pathogen may be useful for designing drugs to target structurally or functionally significant parts of the pathogen. However, identifying structurally or functionally significant nucleotide sequences may have other uses. Such uses may include identifying patterns of gene structure and organization, identifying critical genes/pathways in a pathogen, identifying latent pathogen genes in environmental genomes, identifying potential new or emergent pathogen diseases, or identifying patterns of emergent pathogen evolution. It will be understood by one skilled in the art that in these applications, the following step 210 may be omitted.

In step 210, a drug is developed to interact with at least one amino acid sequence encoded by the previously identified, structurally or functionally significant nucleotide sequence. In an exemplary embodiment, an antibiotic drug is designed to target a nucleotide sequence having a high selection score in a pathogen. In a further exemplary embodiment, an antibiotic drug is designed to target a nucleotide sequence having a high selection score in multiple pathogens, to increase the effectiveness of the drug. The development of a drug to target a selected nucleotide sequence will be known to one of skill in the art.

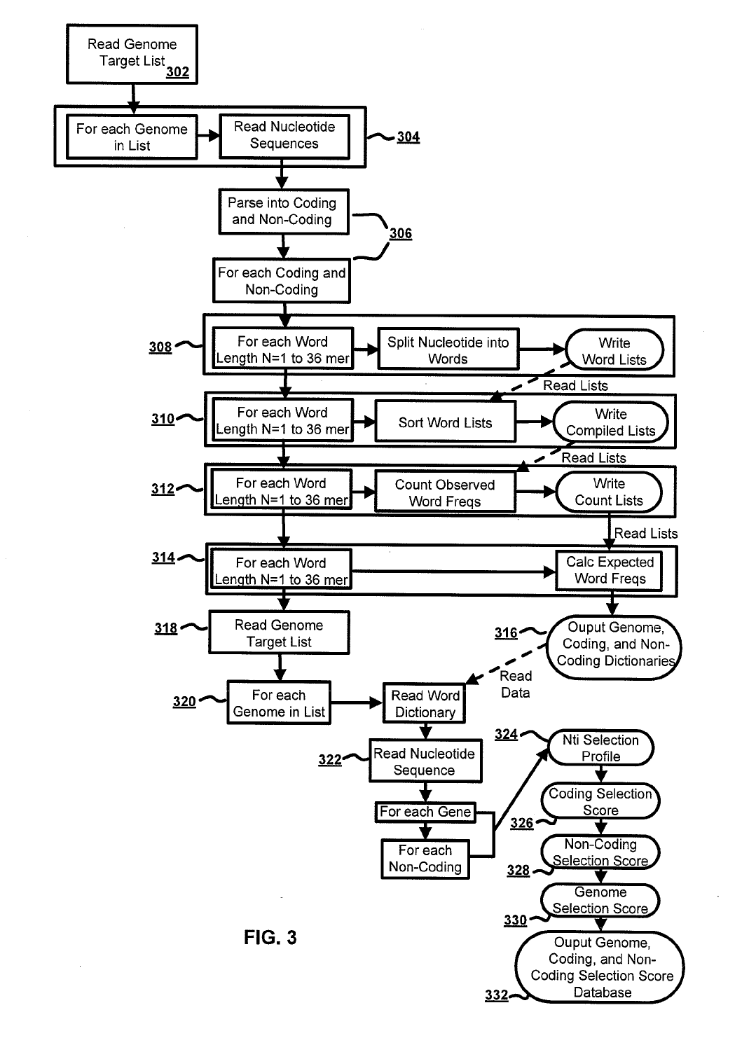

FIG. 3 is a flow chart of exemplary steps for identifying significant nucleotide sequences in accordance with an aspect of the present invention. To facilitate description, the steps of FIG. 3 are described with reference to the system components of FIG. 1. It will be understood by one of skill in the art from the description herein that one or more steps may be omitted and/or different components may be utilized without departing from the spirit and scope of the present invention.

In step 302, a genome target list is read. In an exemplary embodiment, processor 103 receives a genome target list from input/output interface 108. The genome target list may include one or more genomes identified by a user for which nucleotide word dictionaries are desired to be created. For example, a user doing research on human pathogenic bacteria may identify particularly virulent pathogens for inclusion in the genome target list. In one exemplary embodiment, the genome target list could be obtained from the public databases of the National Center for Biotechnology Information. In another exemplary embodiment, the genome target list could consist of synthetic genomes determined by creating a random, symmetrical codon table with exactly three codons per amino acid and then by randomly sampling nucleotides from the table. While these are examples of obtaining and creating genome target lists, it will be understood by one skilled in the art that other methods of obtaining and creating genome target lists are possible.

In step 304, the nucleotide sequences in each genome on the genome target list are read. In an exemplary embodiment, the nucleotide sequences may be stored in mass storage device 104 and/or in system memory 110.

In step 306, the nucleotide sequences are categorized for further analysis based on whether they originate from parts of the genome responsible for coding proteins or from non-coding regions. In an exemplary embodiment, the genome target list can contain nucleotide sequences that hold known start and stop codons which can be used to define whether the nucleotide sequences originate from parts of the genome responsible for coding proteins or from non-coding regions.

Generally, three nucleotide bases specify one amino acid in the genetic code. The first three bases of the coding sequence of messenger RNA to be translated into protein are called a start codon. A stop codon is a nucleotide triplet within messenger RNA that signals a termination of translation. The sequences between a start and stop codon are defined as coding, and the following sequences between the stop codon and the next start codon are defined as non-coding. However, it will be understood by one skilled in the art that using a genome target list with known start and stop codons is only one example of a way of identifying coding or non-coding sequences.

In step 308, word lists are written for each nucleotide sequence. In an exemplary embodiment, processor 103 splits each nucleotide sequence into nucleotide words having a length of between one and thirty six nucleotides, although other lengths are contemplated. Processor 103 may write a list containing each nucleotide word occurring in the nucleotide sequence to mass storage device 104 and/or in system memory 110.

In step 310, the list of the words occurring in each nucleotide sequence is compiled. In an exemplary embodiment, processor 103 may compile the list of each nucleotide word occurring more than once in the nucleotide sequences. The compiled nucleotide word list may be stored in mass storage device 104 and/or in system memory 110.

In step 312, the observed frequency of each nucleotide word in the nucleotide sequence is counted and written to a count list. In an exemplary embodiment, processor 103 may count the observed occurrences of each nucleotide word in the compiled list. Processor 103 may calculate the frequency of each nucleotide word in each nucleotide sequence in the genome by dividing the observed number of occurrences for each nucleotide word by the number of nucleotides in the nucleotide or genome. Processor 103 may then write a list including the frequency for each nucleotide word in the nucleotide sequences. The list containing the observed nucleotide word frequency may be stored in mass storage device 104 and/or in system memory 110.

In step 314, the expected frequency of each nucleotide word in each nucleotide sequence is calculated. In an exemplary embodiment, the expected frequency of each nucleotide word in a nucleotide sequence may be derived from the probability of each nucleotide word in the nucleotide sequence occurring. Processor 103 may calculate the probability of a nucleotide word based on the probability of the occurrence of two or more nucleotide subwords making up nucleotide word.

An exemplary algorithm for determining the probability of the occurrence of an nucleotide word in the nucleotide sequence may involve calculating the probability from the observed frequency of each nucleotide word in the nucleotide sequence. The probability of a 1-long nucleotide word (i.e. a single nucleotide) occurring within the nucleotide sequence is equal to the frequency of the nucleotide, i.e. the number of occurrences of that nucleotide divided by the total number of nucleotides in the genome. For example, if the nucleotide “A” (for Adenine) occurs 11 times in a sample of 100 nucleotides, then the probability of the 1-long nucleotide p(A) is 11%. For a 2-long nucleotide word, the probability may be determined to be one half of the probability of the first 1-long nucleotide subword multiplied by the probability of the second 1-long nucleotide subword. For example, if p(A) is 11%, and p(G) (for the 1-long nucleotide word for Guanine “G”) is 8%, then p(AG) (for the 2-long nucleotide word “AG”) would be equal to one half of 0.11*0.08, or 0.44% (with the same probability existing for p(GA)). For N-long nucleotide words (where N>2), the probability may be determined based on the probability of a 1-long nucleotide subword and a (N−1)-long nucleotide subword. For example, the probability of the nucleotide word “ACTG” occurring may be equal to the average of p(ACT)*p(G) and p(A)*p(CTG).

Using this algorithm, processor 103 may calculate the probability of any nucleotide word occurring based on the probability of two or more subwords of the nucleotide word, which may be obtained using the list of observed frequencies of nucleotide words in each genome. Processor 103 may calculate the expected frequency of a nucleotide word by multiplying the probability of the nucleotide word occurring with the total number of nucleotides in the genome. The expected frequency of a nucleotide word may be stored in mass storage device 104 and/or in system memory 110.

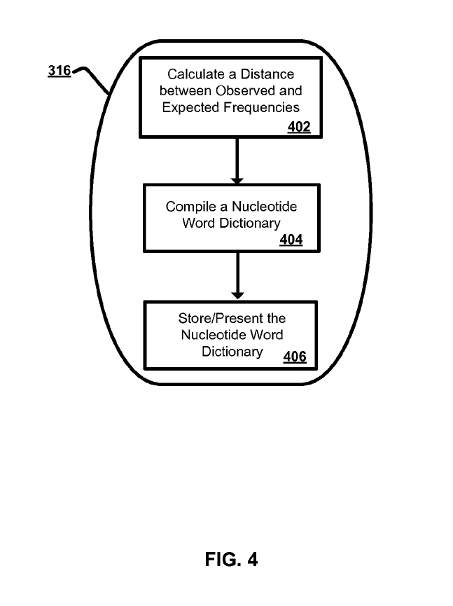

In step 316, genome, coding, and non-coding word dictionaries are output, e.g., stored in mass storage device 104 and/or in system memory 110 and/or transmitted to display device 109. In an exemplary embodiment, processor 103 generates a nucleotide word dictionary for each genome. In another exemplary embodiment, processor 103 generates a nucleotide word dictionary for each coding and non-coding nucleotide sequence previously categorized in step 306. The nucleotide word dictionary may contain an entry for each nucleotide word in each nucleotide sequence in the genome. Each entry for the nucleotide word may include the word's observed frequency, expected frequency, and/or the difference between the observed and expected frequencies. After generating the nucleotide word dictionary for each genome, processor 103 may then store the nucleotide word dictionary in mass storage device 104 and/or in system memory 110 for later access. Additionally, processor 103 may transmit electronic data including nucleotide word dictionaries for each nucleotide word in the genome to display device 109. Display device 109 may then present the nucleotide word dictionaries to a user via a chart or graph, for example. FIG. 4, described below, depicts a flow chart of exemplary steps for performing step 316.

In step 318, a genome target list is read. Processor 103 may receive the genome target list from input/output interface 108. The genome target list may be generated by a user. In an exemplary embodiment, the genome target list may be the same list of genomes read in step 302. In an alternative exemplary embodiment, the genome target list may be a list including genomes for which nucleotide word dictionaries have been created, as described above in steps 304-316.

In step 320, the nucleotide word dictionaries for each genome on the genome target list are read. In an exemplary embodiment, processor 103 accesses nucleotide word dictionaries stored by mass storage device 104 and/or in system memory 110. In another exemplary embodiment, processor 103 accesses nucleotide word dictionaries for each coding and non-coding nucleotide sequence. Processor 103 then reads the nucleotide word dictionaries for each genome on the genome target list.

In step 322, the nucleotide sequences for each genome in the genome target list are read. In an exemplary embodiment, processor 103 may read each genome on the genome target list to determine what nucleotide sequences it encodes in order to separately analyze each nucleotide sequence.

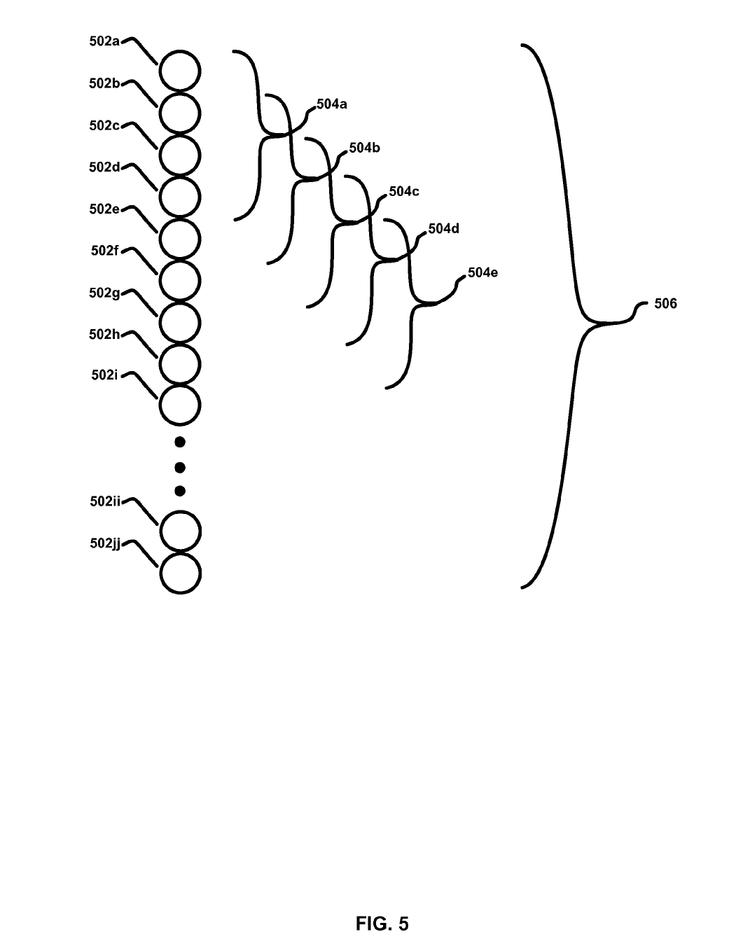

In step 324, a nucleotide sequence selection score is determined for the nucleotide sequences in each gene and each non-coding nucleotide sequence. In an exemplary embodiment, processor 103 calculates a nucleotide sequence selection score based on the nucleotide word dictionaries for each nucleotide word in each gene and each non-coding nucleotide sequence. Processor 103 may assign a nucleotide selection score to each nucleotide occurring in each gene and each non-coding nucleotide sequence. In this exemplary embodiment, the nucleotide selection score may be calculated by summing the distances between the observed and expected frequencies for each 3-long, 4-long, 5-long, and 6-long word containing the nucleotide. Processor 103 may then examine all 37-long nucleotide sequences in each genome. Processor 103 may determine a nucleotide sequence selection score for each 37-long nucleotide sequence by summing the nucleotide selection scores for each nucleotide contained in the nucleotide sequence. The nucleotide sequence selection score may be stored in mass storage device 104 and/or in system memory 110. FIG. 5, described below, depicts an exemplary nucleotide sequence for further explaining the determination of a selection score in step 322. Further, one skilled in the art will appreciate that the systems and methods disclosed herein can determine a selection score for 12-long, 15-long, 18-long, or any length of nucleotide words in coding sequence domains.

In step 326, a coding selection score is determined. In an exemplary embodiment, processor 103 may calculate a coding selection score for each nucleotide sequence by summing the nucleotide sequence selection scores for each 37-long nucleotide sequence in the target list. The coding selection score may be stored in mass storage device 104 and/or in system memory 110.

In step 328, a non-coding selection score is determined. In an exemplary embodiment, processor 103 may calculate a non-coding selection score for each for each nucleotide sequence by summing the nucleotide sequence selection scores for each 37-long nucleotide sequence in the target list. The non-coding selection score may be stored in mass storage device 104 and/or in system memory 110.

In step 330, a genome selection score is determined. In an exemplary embodiment, processor 103 may calculate a genome selection score for the genome by summing the nucleotide selection scores for each nucleotide sequence in the genome. The genome selection score may be stored in mass storage device 104 and/or in system memory 110.

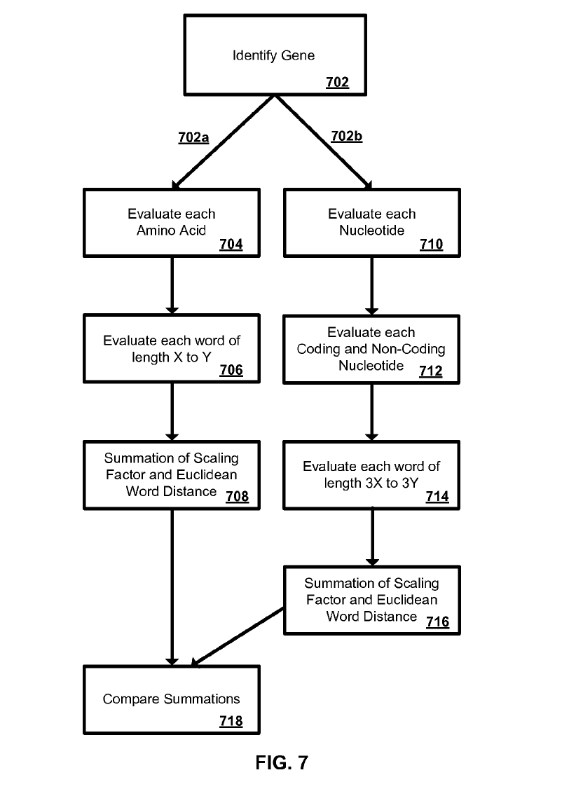

In step 332, a genome selection score, coding selection score, and/or non-coding selection score database are output. In one exemplary embodiment, the nucleotide sequence selection score, the coding selection score, the non-coding selection score, and the genome selection score are stored in mass storage device 104 and/or in system memory 110. In another exemplary embodiment, the electronic data is transmitted to display device 109. The electronic data may include the nucleotide sequence selection score, the coding selection score, the non-coding selection score, and the genome selection score. Display device 109 may then present the selection scores to a user via, for example, a chart or graph indicating the comparative height of the selection scores for the one or more structurally or functionally significant nucleotide sequences. FIG. 7 depicts an exemplary chart for depicting the selection scores for a set of nucleotide sequences, as will be discussed below.

FIG. 4 is a flow chart of exemplary steps for outputting genome, coding, and non-coding word dictionaries (step 316; FIG. 3) in accordance with an aspect of the present invention.

In step 402, a distance between the observed and expected frequencies of each nucleotide word is calculated. In an exemplary embodiment, processor 103 compares the observed frequency for each nucleotide word in each genome with the expected frequency for each nucleotide word in each genome. Processor 103 may utilize a standard Euclidean distance calculation in order to plot a point in a two-dimensional space corresponding to the observed and expected frequencies of a nucleotide word. The two dimensions may be the observed frequency and the expected frequency for nucleotide words, with each plotted point corresponding to those frequencies for an nucleotide word. The two dimensions may vary linearly or logarithmically. Processor 103 may then compute a linear distance between the plotted point and a hypothetical 1:1 reference line in the two-dimensional space. The 1:1 reference line may correspond to points on the graph where the observed frequency is equal to the expected frequency for a nucleotide word. The calculated distance may be the perpendicular distance between the observed vs. expected frequency point for a nucleotide word and the 1:1 reference line, and may be calculated using Euclidean geometry.

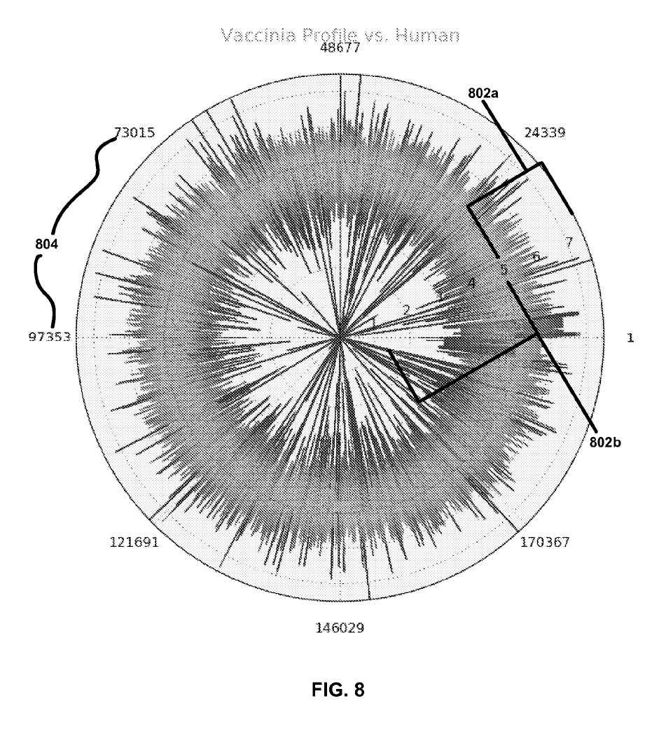

In an aspect, the methods and systems can identify natural selection forces in non-coding DNA sequences. FIG. 8 illustrates a circular viral plot demonstrating a new type of comparison where the selection scores of nucleotides in one genome (a virus) are compared to another (a host). Common interactions between a pathogen and a host can include an immune response, the release of toxins (proteins) by the pathogen and other “direct” interactions. Comparisons of DNA selection scores (especially in non-coding DNA) reveals other subtler regulatory interactions between pathogen and host. An example is gene-silencing by a pathogen ncRNA (non-coding RNA). Significant differences in host versus pathogen selection scores are prime targets to begin to uncover how the pathogen actually regulates host biology.

In an alternative exemplary embodiment, processor 103 may calculate a distance between the observed and expected frequencies for each nucleotide word by determining the difference between the two frequencies through subtraction. The calculated distance between the observed and expected frequencies may be stored in mass storage device 104 and/or in system memory 110.

In step 404, a nucleotide word dictionary is compiled for each coding sequence, non-coding sequence, and genome. In an exemplary embodiment, processor 103 compiles a nucleotide word dictionary for each nucleotide word in each genome. The nucleotide word dictionary may include an entry for each nucleotide word in each genome. Each entry may include the observed frequency, expected frequency, and calculated distance between the two frequencies for the nucleotide word.

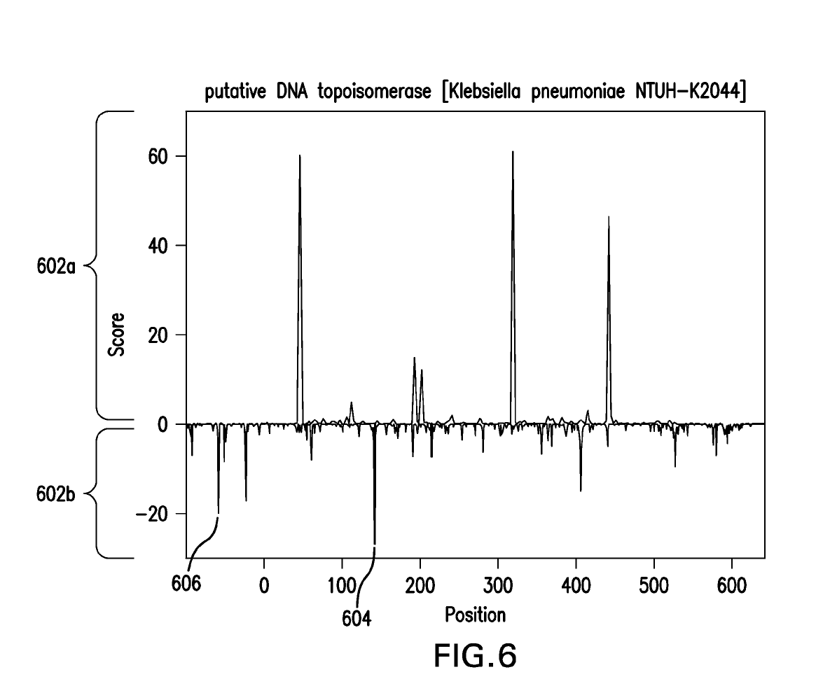

In step 406, the nucleotide word dictionary for each genome is stored and/or presented. In one exemplary embodiment, the nucleotide word dictionary for each genome may be stored in mass storage device 104 and/or in system memory 110. In another exemplary embodiment, processor 103 may transmit electronic data to output display adapter 107. The electronic data may include the nucleotide word dictionary for each genome. Display device (s) 109 may then present the nucleotide word dictionary to a user by, for example, a chart or graph depicting the calculated distance between observed and expected frequencies for each nucleotide word in each genome presented on a monitor or printed on paper. Electronic data transmitted to output display adapter 107 may be at least temporarily stored, e.g., in a video buffer (not shown). FIG. 6, described below, depicts an exemplary graph for depicting the calculated distance between observed and expected frequencies for each nucleotide word in each nucleotide sequence, as will be discussed below.

FIG. 5 is an illustration for use in explaining the determination of a nucleotide sequence selection score for a nucleotide sequence as described in step 324 of FIG. 3, in accordance with an aspect of the present invention. FIG. 5 depicts 36 nucleotides (nucleotides 502a-502jj), five nucleotide words (nucleotide words 504a-504e), and one nucleotide sequence (nucleotide sequence 506). Additional details for determining a selection score are provided below:

The selection score for a nucleotide sequence may be determined based on the selection score for each nucleotide in the sequence. FIG. 5 depicts a sample sequence of nucleotides 502a-502jj in a nucleotide sequence. In an exemplary embodiment, processor 103 examines every 4-long, 5-long, and 6-long nucleotide word in each nucleotide sequence. As noted above, one skilled in the art will appreciate that the systems and methods disclosed herein can determine a selection score for 12-long, 15-long, 18-long, or any length of nucleotide words in coding sequence domains. FIG. 5 depicts a series of 4-long nucleotide words 504a-504e. For example, nucleotide word 504a includes nucleotides 502a-502d; nucleotide word 504b includes nucleotides 502b-502e; and so on.

Each nucleotide word 504a-504e has a corresponding calculated distance between the word's observed and expected frequency, as contained in the nucleotide word dictionary generated in 316. For each examined word 504a-504e, the calculated distance for the nucleotide word is added to each nucleotide in the nucleotide word to generate a selection score for each nucleotide. For example, assume nucleotide word 504a has a calculated distance of 5; word 504b has a calculated distance of 6; word 504c has a calculated distance of 4; word 504d has a calculated distance of 6; and word 504e has a calculated distance of 7. In this example, the selection score for nucleotide 502d would be the sum of the calculated distances for nucleotide words 504a-504d, or 21 (5+6+4+6); the selection score for nucleotide 502e would be the sum of the calculated distances for nucleotide words 504b-504e, or 23 (6+4+6+7).

In an exemplary embodiment, processor 103 performs this summation for each nucleotide in the nucleotide sequence using all 4-long nucleotide words (e.g. 504a-504e), 5-long nucleotide words (not shown), and 6-long nucleotide words (not shown). Processor 103 may then examine all 37-long nucleotide sequences in the genome. Processor 103 may determine a selection score for each 37-long nucleotide sequence in each genome by summing the selection scores for each nucleotide contained in the nucleotide sequence. For example, the selection score for 37-long nucleotide sequence 506 would be the sum of the selection scores for nucleotides 502a-502jj. Processor 103 may store the selection score for the nucleotide sequence in mass storage device 104 and/or in system memory 110.

FIG. 6 is an exemplary illustration of a comparison of the word statistics in genes between the nucleotide and amino acid sequences of Klebsiella pneumoniae NTUH-K2044, in accordance with an aspect of the present invention. FIG. 6 depicts an example of the selection score described above as the Euclidean distance between observed and expected word frequencies as summed at every amino acid or nucleotide position along the length of a gene or any non-coding DNA sequence. This example shows a comparison that illustrates the degree to which natural selection has shaped the amino acid sequence composition versus the nucleotide sequence composition for a gene. 602a denotes amino acid word scores while 602b denotes nucleotide word scores. Peaks in functional significance are expected in protein sequences because natural selection directly acts upon amino acid positions. Peaks, such as 604, in the nucleotide plot indicate natural selection forces that are active on the nucleotides, but for a different biological function other than coding for corresponding amino acids. The selection scores are compared because there is more information in triplet codons than is necessary to make the 20 amino acids. Thus, comparisons of selection scores between the nucleotide words and amino acids words reveal significant differences. Further, open reading frames contain information in nucleotides that is non-coding for amino acid information but could be a potential non-coding RNA, an alternative splice site for the message RNA, or other information beyond which amino acid is coded for. Spikes, such as 606, in the nucleotide score 602b where there are no spikes in the amino acid score 602a can be ranked in the same manner, as discussed above, as the selection score of a protein or coding region for further experimentation.

FIG. 7 is a flow chart of exemplary steps for comparing differences in nucleotide sequences and amino acid sequences. To facilitate description, the steps of FIG. 7 are described with reference to the system components of FIG. 1. It will be understood by one of skill in the art from the description herein that one or more steps may be omitted and/or different components may be utilized without departing from the scope of the present invention.

In step 702, a gene to be analyzed is identified and stored. In an exemplary embodiment, processor 103 receives data relating to the genome from input/output interface(s) 108. Processor 103 may then begin the following steps for each gene. Amino acids are evaluated down path 702a while nucleotides are evaluated down path 702b.

In step 704, each amino acid in the gene from 702 is evaluated by processor 103 to determine the word size as previously described above. The determined word sizes may then be stored in mass storage device 104 and/or in system memory 110.

In step 706, each amino acid word from 702 is evaluated by processor 103 to be used in the next step. The word lengths can vary in length according to user preference. The user can specify that the word length start at value X and go to value Y. For example, the user could specify that X=4 and Y=6, where at every position in the amino acid, words of length 4, 5 and 6, would be found to be used later to calculate the Euclidean distance that corresponds to the word length. The user specified determined word sizes may then be stored in mass storage device 104 and/or in system memory 110

In step 708, summations are created by processor 103 using Σ(Zₓ·(d_{w})), where Z_{w}, is the scaling factor for word size W and d_{w}, is the Euclidian word distance for each amino acid. The summations may then be stored in mass storage device 104 and/or in system memory 110.

In step 710, each nucleotide in the gene from 702 is evaluated by processor 103 to determine the word size as previously described above. The determined word sizes may then be stored in mass storage device 104 and/or in system memory 110.

In step 712, each coding and non-coding nucleotide in the gene from 702 is evaluated by processor 103 to determine the word size as previously described above. The determined word sizes may then be stored in mass storage device 104 and/or in system memory 110.

In step 714, each nucleotide word from 712 is evaluated by processor 103 to be used in the next step. The word lengths can vary in length according to user preference. The user can specify that the word length start at value 3X and go to value 3Y. For example, the user could specify that X=4 and Y=6, where at every position in the amino acid words of length 12, 13, 14, 15, 16, 17, and 18 would be found to be used later to calculate the Euclidean distance that corresponds to the length of the word. The user specified determined word sizes may then be stored in mass storage device 104 and/or in system memory 110

In step 716, summations are created by processor 103 using Σ(Z_{w}·(d_{w})), where Z_{w} is the scaling factor for word size W and d_{w} is the Euclidian word distance for each nucleotide, coding nucleotide, and non-coding nucleotide. The summations may then be stored in mass storage device 104 and/or in system memory 110.

In step 718, the summations from 708 and 716 may be compared by processor 103 using different statistical methods to determine significant sequences. An exemplary method of statistical scoring would be using subtraction as described earlier in FIG. 4 step 402. Another example of statistical scoring of the summations would be to create a ratio by dividing the summation of 708 by the summation of 716, using either the entire nucleotide, or the coding or non-coding parts of the nucleotide. The calculated comparisons may then be stored in mass storage device 104 and/or in system memory 110. The calculated comparisons may also be output to display device 109.

FIG. 8 is an exemplary illustration of the results of a comparison of the nucleotide word information from one genome (a Virus) to that of the another genome (the viral host), in accordance with an aspect of the present invention. This type of comparison of nucleotide information at the whole genome or gene level reveals areas of major differences and similarities that exceed simple comparison word-matching. FIG. 8 is a comparison of the viral genome Vaccinia to the human genome. 802a identifies outer rings 5-7 where nucleotide information that is unique to the Vaccinia genome when compared to Homo sapien is plotted. 802b identifies inner rings 1-4 where regions common to both organisms (Vaccinia and Homo sapien) are plotted. The area identified by 802b represents potential areas of viral integration, regulation or host control by virus. 804 identifies several numeric indicators located outside the graph that each denote a coding or non coding region.

Interactive effects between host and pathogen DNA can be important in pathogenesis. For example, a pathogen that has gene silencing potential for the host that also performs the same function on itself is self-defeating. The pathogen genome can be scanned for each word, gene fragment or non-coding region that is completely unique between host and pathogen in an attempt to reveal something about the fundamental nature of the interaction. However, uniqueness at this level is not revealing. In contrast, the methods and systems provided can determine motifs and words that statistically “don't belong” (over-expected) or “should be there more” (under-expected). Such “word finding” can make use of selection scores of words and form generalized words (words that have differences at a few positions). For example, a motif “GGATNTTCNC” can be found where N is any of the 4 nucleotides in a pathogen that has a high combined average selection score that is antisense (for example) to a very under-expected area of the human genome that is crucial for the regulation of a key biochemical pathway. With this approach the number of targets for experimental verification is lowered.

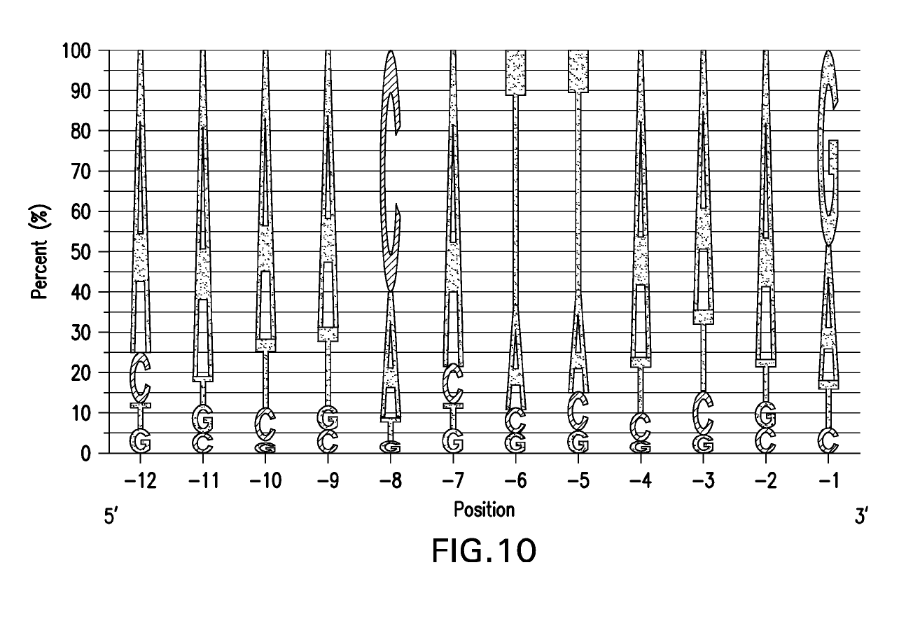

In another aspect, provided are targeting methods and systems using the most prevalent word types. The over-abundance of word “types” or certain defined degeneracy can be calculated for genes and genomes as in FIG. 10. Degeneracy can be defined as a percentage, where the percentage can be from 0%-100%. An exemplary embodiment has a 20% degeneracy. Here all combinations of 12 mer words that share at least 8 or 12 positions AND are statistically over-represented can be determined for similar purposes as described above (regulatory sites, non-coding RNAs, up-stream promoters, etc.).

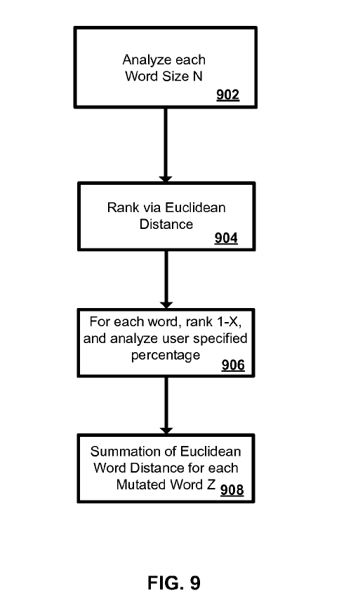

Illustrated in FIG. 9, provided are methods and systems comprising determining selection score on at least two genomes at step 902. Here, each user defined word size is analyzed and stored to be used in the next step. In step 904, each word is used to compare the similarities and major differences and then ranked according to the calculated Euclidean distance. In step 906, the rankings are redone by analyzing each word by a user defined base number and determining which words are similar. At step 908, the search is expanded by using the “most prevalent word types” found in step 906. For example, the top 20% of the rankings may comprise the “most prevalent word types.”

This approach combines selection score with pattern matching. For example, at steps 902 and 904, what 8 mer word has the highest selection score? At step 906, degrade this word by any 2 bases and find all the words like it and accumulate the selection scores. At step 906, repeat with the next highest selection score and compile a list. This approach combines the selection scoring methods to word patterns and utilizes the concept in evolution that some mutations are strictly neutral (have no effect). Thus there could be 8 mer words that are closely related by 4, 5 or 6 amino acids and would be lost in an analysis of strict matching. This technique applies to amino acids and nucleotides.

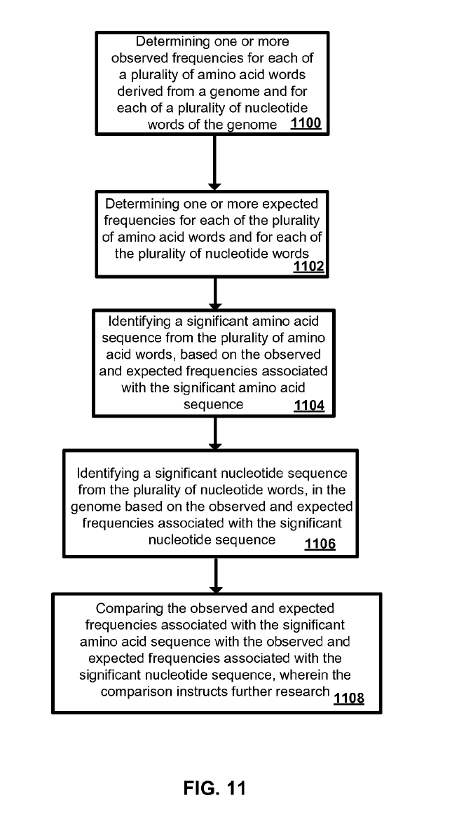

In an aspect, illustrated in FIG. 11, provided are methods, systems, and computer readable media for comparing word statistics between a significant amino acid sequence and a significant nucleotide sequence, comprising determining, using a computer, one or more observed frequencies for each of a plurality of amino acid words derived from a genome and for each of a plurality of nucleotide words of the genome at 1100, determining one or more expected frequencies for each of the plurality of amino acid words and for each of the plurality of nucleotide words at 1102, identifying a significant amino acid sequence from the plurality of amino acid words, based on the observed and expected frequencies associated with the significant amino acid sequence at 1104, identifying a significant nucleotide sequence from the plurality of nucleotide words, in the genome based on the observed and expected frequencies associated with the significant nucleotide sequence at 1106, and comparing the observed and expected frequencies associated with the significant amino acid sequence with the observed and expected frequencies associated with the significant nucleotide sequence, wherein the comparison instructs further research at 1108.

Identifying a significant amino acid sequence and identifying a significant nucleotide sequence can comprise determining a first selection score for an amino acid sequence based on the difference between the observed and expected frequencies for each of the plurality of amino acid words derived from the genome, the first selection score corresponding to the structural significance of the amino acid sequence, identifying a significant amino acid sequence based on the selection score for the amino acid sequence, determining a second selection score for a nucleotide sequence based at least on the difference between the observed and expected frequencies for each of the plurality of nucleotide words, the second selection score corresponding to the coding or non-coding significance of the nucleotide sequence, and identifying a significant nucleotide sequence based on the selection score for the nucleotide sequence.

Determining one or more expected frequencies can comprise determining with the computer a first expected frequency for each of the plurality of amino acid words, determining with the computer a second expected frequency for each of the plurality of nucleotide words, determining with the computer a third expected frequency for each of the plurality of nucleotide words responsible for coding proteins, and determining with the computer a fourth expected frequency for each of the plurality of nucleotide words responsible for non-coding regions.

Determining one or more expected frequencies can comprise determining with the computer a first expected frequency of two or more amino acid subwords occurring within each of the plurality of amino acid words, determining with the computer a second expected frequency of two or more nucleotide subwords occurring within each of the plurality of nucleotide words encoded by the genome, determining with the computer a third expected frequency of two or more nucleotide subwords occurring within each of the plurality of nucleotide words responsible for coding proteins, and determining with the computer a fourth expected frequency of two or more nucleotide subwords occurring within each of the plurality of nucleotide words responsible for non-coding regions.

The plurality of nucleotide words can comprise nucleotide words having from one to thirty seven nucleotides. Comparing the observed and expected frequencies associated with the significant amino acid sequence with the observed and expected frequencies associated with the significant nucleotide sequence can comprise comparing the first selection with the second selection score.

Comparing the identified significant amino acid sequence and the identified significant nucleotide sequence can comprise determining a difference between the first selection score and the second selection score and plotting the difference between the first selection score and the second selection score.

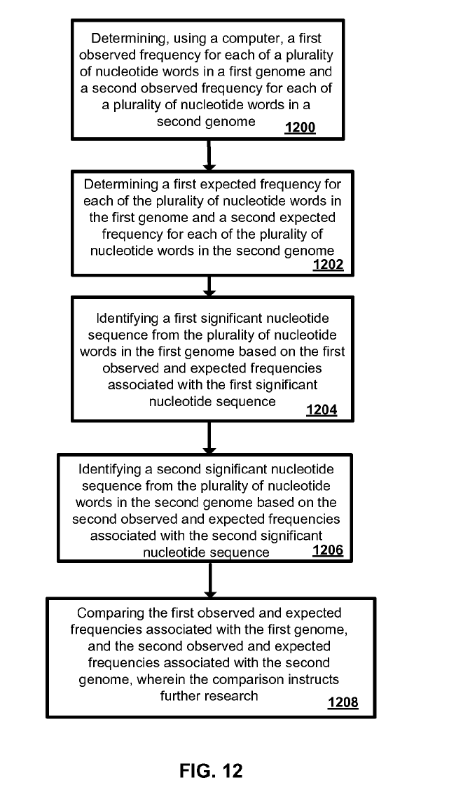

In an aspect, illustrated in FIG. 12, provided are methods, systems, and computer readable media for identifying a significant nucleotide sequence, comprising determining, using a computer, a first observed frequency for each of a plurality of nucleotide words in a first genome and a second observed frequency for each of a plurality of nucleotide words in a second genome at 1200, determining a first expected frequency for each of the plurality of nucleotide words in the first genome and a second expected frequency for each of the plurality of nucleotide words in the second genome at 1202, identifying a first significant nucleotide sequence from the plurality of nucleotide words in the first genome based on the first observed and expected frequencies associated with the first significant nucleotide sequence at 1204, identifying a second significant nucleotide sequence from the plurality of nucleotide words in the second genome based on the second observed and expected frequencies associated with the second significant nucleotide sequence at 1206, and comparing the first observed and expected frequencies associated with the first genome, and the second observed and expected frequencies associated with the second genome, wherein the comparison instructs further research at 1208.

Identifying a first significant nucleotide sequence in the first genome can comprise determining a first selection score for a nucleotide sequence based on the difference between the first observed and expected frequencies for each of the plurality of nucleotide words in the first genome, and identifying a first significant nucleotide sequence based on the first selection score for the nucleotide sequence.

Identifying a second significant nucleotide sequence in the second genome can comprise determining a second selection score for a nucleotide sequence based on the difference between the second observed and expected frequencies for each of the plurality of nucleotide words in the second genome, and identifying a second significant nucleotide sequence based on the second selection score for the nucleotide sequence.

The first genome can comprise a virus and the second genome can comprise a human genome. Identifying a significant nucleotide sequence can comprise determining a selection score for each of the identified first and second significant nucleotide sequences, ranking each significant nucleotide sequence by selection score, and determining prevalent word types by ranking the significant nucleotide sequences that are shared between the first and second genomes and are statistically over-represented.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims or inventive concepts.

What is claimed:

1. A method for comparing word statistics between a significant amino acid sequence and a significant nucleotide sequence, comprising:
determining, using a computer, one or more observed frequencies for each of a plurality of amino acid words derived from a genome and for each of a plurality of nucleotide words of the genome;
determining one or more expected frequencies for each of the plurality of amino acid words and for each of the plurality of nucleotide words;
identifying a significant amino acid sequence from the plurality of amino acid words, based on the observed and expected frequencies associated with the significant amino acid sequence;
identifying a significant nucleotide sequence from the plurality of nucleotide words, in the genome based on the observed and expected frequencies associated with the significant nucleotide sequence; and
comparing the observed and expected frequencies associated with the significant amino acid sequence with the observed and expected frequencies associated with the significant nucleotide sequence, wherein the comparison instructs further research.

2. The method of claim 1, wherein identifying a significant amino acid sequence and identifying a significant nucleotide sequence comprises:
determining a first selection score for an amino acid sequence based on the difference between the observed and expected frequencies for each of the plurality of amino acid words derived from the genome, the first selection score corresponding to the structural significance of the amino acid sequence;
identifying a significant amino acid sequence based on the selection score for the amino acid sequence;
determining a second selection score for a nucleotide sequence based at least on the difference between the observed and expected frequencies for each of the plurality of nucleotide words, the second selection score corresponding to the coding or non-coding significance of the nucleotide sequence; and
identifying a significant nucleotide sequence based on the selection score for the nucleotide sequence.

3. The method of claim 1 wherein determining one or more expected frequencies comprises:
determining with the computer a first expected frequency for each of the plurality of amino acid words;
determining with the computer a second expected frequency for each of the plurality of nucleotide words;
determining with the computer a third expected frequency for each of the plurality of nucleotide words responsible for coding proteins; and
determining with the computer a fourth expected frequency for each of the plurality of nucleotide words responsible for non-coding regions.

4. The method of claim 1 wherein determining one or more expected frequencies comprises:
determining with the computer a first expected frequency of two or more amino acid subwords occurring within each of the plurality of amino acid words;
determining with the computer a second expected frequency of two or more nucleotide subwords occurring within each of the plurality of nucleotide words encoded by the genome;
determining with the computer a third expected frequency of two or more nucleotide subwords occurring within each of the plurality of nucleotide words responsible for coding proteins; and
determining with the computer a fourth expected frequency of two or more nucleotide subwords occurring within each of the plurality of nucleotide words responsible for non-coding regions.

5. The method of claim 1, wherein the plurality of nucleotide words comprises nucleotide words having from one to thirty seven nucleotides.

6. The method of claim 2, wherein comparing the observed and expected frequencies associated with the significant amino acid sequence with the observed and expected frequencies associated with the significant nucleotide sequence, comprises:
comparing the first selection with the second selection score.

7. The method of claim 2, wherein comparing the identified significant amino acid sequence and the identified significant nucleotide sequence comprises:
determining a difference between the first selection score and the second selection score; and
plotting the difference between the first selection score and the second selection score.

8. A method for identifying a significant nucleotide sequence comprising:
determining, using a computer, a first observed frequency for each of a plurality of nucleotide words in a first genome and a second observed frequency for each of a plurality of nucleotide words in a second genome;
determining a first expected frequency for each of the plurality of nucleotide words in the first genome and a second expected frequency for each of the plurality of nucleotide words in the second genome;
identifying a first significant nucleotide sequence from the plurality of nucleotide words in the first genome based on the first observed and expected frequencies associated with the first significant nucleotide sequence;
identifying a second significant nucleotide sequence from the plurality of nucleotide words in the second genome based on the second observed and expected frequencies associated with the second significant nucleotide sequence; and
comparing the first observed and expected frequencies associated with the first genome, and the second observed and expected frequencies associated with the second genome, wherein the comparison instructs further research.

9. The method of claim 8, wherein identifying a first significant nucleotide sequence in the first genome comprises:
determining a first selection score for a nucleotide sequence based on the difference between the first observed and expected frequencies for each of the plurality of nucleotide words in the first genome; and
identifying a first significant nucleotide sequence based on the first selection score for the nucleotide sequence.

10. The method of claim 8, wherein identifying a second significant nucleotide sequence in the second genome comprises:
determining a second selection score for a nucleotide sequence based on the difference between the second observed and expected frequencies for each of the plurality of nucleotide words in the second genome; and
identifying a second significant nucleotide sequence based on the second selection score for the nucleotide sequence.

11. The method of claim 8, wherein the first genome comprises a virus and the second genome comprises a human genome.

12. The method of claim 8, further comprising:
determining a selection score for each of the identified first and second significant nucleotide sequences;
ranking each significant nucleotide sequence by selection score; and
determining prevalent word types by ranking the significant nucleotide sequences that are shared between the first and second genomes and are statistically over-represented.

13. A computer program product for comparing word statistics between a significant amino acid sequence and a significant nucleotide sequence, said computer program product comprising a memory element storing one or more code segments, said code segments comprising instructions for implementing the steps of:
determining one or more observed frequencies for each of a plurality of amino acid words derived from a genome and for each of a plurality of nucleotide words of the genome;
determining one or more expected frequencies for each of the plurality of amino acid words and for each of the plurality of nucleotide words;
identifying a significant amino acid sequence from the plurality of amino acid words, based on the observed and expected frequencies associated with the significant amino acid sequence;
identifying a significant nucleotide sequence from the plurality of nucleotide words, in the genome based on the observed and expected frequencies associated with the significant nucleotide sequence; and
comparing the observed and expected frequencies associated with the significant amino acid sequence with the observed and expected frequencies associated with the significant nucleotide sequence, wherein the comparison instructs further research.

14. The computer readable medium of claim 13, wherein the steps of identifying a significant amino acid sequence and identifying a significant nucleotide sequence comprise:
determining a selection score for an amino acid sequence based on the difference between the observed and expected frequencies for each of the plurality of amino acid words derived from the genome, the first selection score corresponding to the structural significance of the amino acid sequence;
identifying a significant amino acid sequence based on the selection score for the amino acid sequence;
determining a selection score for a nucleotide sequence based at least on the difference between the observed and expected frequencies for each of the plurality of nucleotide words, the second selection score corresponding to the coding or non-coding significance of the nucleotide sequence; and
identifying a significant nucleotide sequence based on the selection score for the nucleotide sequence.

15. The computer readable medium of claim 13, wherein the steps of determining one or more expected frequencies comprises:
determining a first expected frequency for each of the plurality of amino acid words;
determining a second expected frequency for each of the plurality of nucleotide words;
determining a third expected frequency for each of the plurality of nucleotide words responsible for coding proteins; and
determining a fourth expected frequency for each of the plurality of nucleotide words responsible for non-coding regions.

16. The computer readable medium of claim 13, wherein the steps of determining one or more expected frequencies comprises:
determining a first expected frequency of two or more amino acid subwords occurring within each of the plurality of amino acid words;
determining a second expected frequency of two or more nucleotide subwords occurring within each of the plurality of nucleotide words encoded by the genome;
determining a third expected frequency of two or more nucleotide subwords occurring within each of the plurality of nucleotide words responsible for coding proteins; and
determining a fourth expected frequency of two or more nucleotide subwords occurring within each of the plurality of nucleotide words responsible for non-coding regions.

17. The computer readable medium of claim 14, wherein the steps of comparing the observed and expected frequencies associated with the significant amino acid sequence with the observed and expected frequencies associated with the significant nucleotide sequence, comprises:
comparing the first selection with the second selection score.

18. The computer readable medium of claim 14, wherein the steps of comparing the identified significant amino acid sequence and the identified significant nucleotide sequence comprises:
determining a difference between the first selection score and the second selection score; and
plotting the difference between the first selection score and the second selection score.

19. The computer readable medium of claim 13, further comprising the steps of:
identifying a first significant nucleotide sequence from the plurality of nucleotide words in the first genome based on the first observed and expected frequencies associated with the first significant nucleotide sequence;
identifying a second significant nucleotide sequence from the plurality of nucleotide words in the second genome based on the second observed and expected frequencies associated with the second significant nucleotide sequence; and
comparing the first observed and expected frequencies associated with the first genome, and the second observed and expected frequencies associated with the second genome, wherein the comparison instructs further research.

20. The computer readable medium of claim 13, wherein the step of identifying a first significant nucleotide sequence in the first genome comprises:
determining a first selection score for a nucleotide sequence based on the difference between the first observed and expected frequencies for each of the plurality of nucleotide words in the first genome; and
identifying a first significant nucleotide sequence based on the first selection score for the nucleotide sequence.

21. The computer readable medium of claim 13, wherein the step of identifying a second significant nucleotide sequence in the second genome comprises:
determining a second selection score for a nucleotide sequence based on the difference between the second observed and expected frequencies for each of the plurality of nucleotide words in the second genome; and
identifying a second significant nucleotide sequence based on the second selection score for the nucleotide sequence.

22. The computer readable medium of claim 13, further comprising the steps of:
determining a selection score for each of the identified first and second significant nucleotide sequences;
ranking each significant nucleotide sequence by selection score; and
determining prevalent word types by ranking the significant nucleotide sequences that are shared between the first and second genomes and are statistically over-represented.
